(19) United States
(12) Patent Application Publication
(10) Pub. No.: US 2009/0091693 A1
(43) Pub. Date: Apr. 9, 2009

(54) DISPLAY PANEL, DISPLAY PANEL FABRICATION METHOD AND REMOVAL APPARATUS

(76) Inventor: Akinori Izumi, Mie (JP)

Correspondence Address: BIRCH STEWART KOLASCH & BIRCH, PO BOX 747, FALLS CHURCH, VA, 22040-0747, US

(21) Appl. No.: 12/282,367

(22) PCT Filed: Jan. 9, 2007
(86) PCT No.: PCT/JP2007/050071

§ 371 Date: Sep. 10, 2008

(30) Foreign Application Priority Data
Mar. 24, 2006 (JP) 2006-083187

(51) Int. Cl. G02F 1/1335; H01J 9/20; H01J 9/00

(52) U.S. Cl. 349/96; 445/25; 445/60

(57) ABSTRACT

A display panel includes a first substrate, a second substrate superposed on the first substrate with liquid crystal posed therebetween to serve as a display layer, a sealing member disposed between the first substrate and the second substrate and surrounding the display layer, a resin layer disposed on at least one of the first substrate and the second substrate at a surface facing away from the display layer, and a polarizing plate stuck on a surface of the resin layer.

### TECHNICAL FIELD

The present invention relates to display panels, display panel fabrication methods and removal apparatuses. A “display panel” as referred to herein indicates a liquid crystal display panel (hereinafter also referred to as a “liquid crystal panel”), an electrochromic display panel, and the like.

### BACKGROUND ART

As a type of display panel, there exists a liquid crystal display panel. In general, a liquid crystal display panel has a structure formed of two glass substrates stacked, one on the other, in parallel and thus stuck together with a predetermined small gap posed therebetween and filled with liquid crystal. As a method of fabricating such a liquid crystal display panel, a conventional, generally employed method will now be described hereinafter with reference to FIGS. 19-22.

As shown in FIG. 19, when a glass substrate 101 serving as a color filter (CF) substrate and a glass substrate 102 serving as a thin film transistor (TFT) substrate are to be stuck together, a sealing member 103 is disposed on one of the substrates. In the FIG. 19 example, glass substrate 101 has a surface with sealing member 103 adhesively fixed thereon. Sealing member 103 is disposed in the form of a frame to define a region that serves as a space confining liquid crystal (hereinafter also referred to as a “liquid crystal cell”). It is, however, not completely closed. It has a portion opened to serve as an inlet 116. Glass substrates 101 and 102 are substrates having a large size allowing a plurality of liquid crystal display panels to be provided therefrom, and sealing member l03 is disposed as a plurality of frames. Sealing member 103 is thermosetting resin or the like.

Glass substrates 101 and 102 are stuck together by sealing member 103. Heat is applied to set sealing member 103. Subsequently glass substrates 101 and 102 are divided for each individual region surrounded by sealing member 103. Thus, as shown in FIG. 20, a stack of substrates 114 including a liquid crystal cell 115 is obtained. The stack of substrates 114 divided has the seal with its opening exposed at a side surface of the stack of substrates. The divided stack of substrates 114 is introduced into a vacuum apparatus and liquid crystal cell 115 is both internally and externally vacuumed. In that condition, as shown in FIG. 21, inlet 116 defined by the opening of sealing member 103 is immersed in liquid crystal 4 and the vacuum apparatus's interior is gradually returned to the atmospheric pressure. By a difference in pressure between the inside and outside of liquid crystal cell 115, and capillarity, liquid crystal 4 is introduced into liquid crystal cell 115. Liquid crystal cell 115 is thus filled with liquid crystal 4. Subsequently, sealing resin 105 of ultraviolet ray curing resin is applied to inlet 116. Sealing resin 105 is exposed to ultraviolet radiation to set to provide the stack of substrates 114 having liquid crystal 4 sealed within liquid crystal cell 115, as shown in FIG. 22.

A conventional liquid crystal display panel, a small size liquid crystal display panel used for example in mobile phones, in particular, is fabricated by dividing a single, large size glass substrate to provide hundreds of liquid crystal display panels. In that case, such a conventional art as described above requires a significantly increased number of operations in the steps for example of sticking a polarizing plate, conducting an inspection, and the like, which is significantly time consuming.

To address this disadvantage, Japanese Patent Laying-Open No. 06-342139 (Patent Document 1) proposes a fabrication method. More specifically, a polarizing plate previously provided with a cut is stuck on an elongate substrate having regions thereon in a row to serve as cells. The intermediate product is then divided for each cell. Furthermore, there is also proposed a fabrication method, as disclosed in Japanese Patent Laying-open No. 2004-004636 (Patent Document 2). More specifically, a polarizing plate having been stuck on a surface of a substrate has a strip region corresponding to a substrate dividing line. With the polarizing plate stuck on the surface of the substrate, the strip region is scraped off to divide the polarizing plate into cells. As a result the surface of the substrate is exposed at the strip region. Subsequently, the substrate is divided.
Patent Document 1: Japanese Patent Laying-open No. 06-342139
Patent Document 2: Japanese Patent Laying-open No. 2004-004636

### DISCLOSURE OF THE INVENTION

### Problems to Be Solved by the Invention

To divide a substrate that has a plurality of liquid crystal cells with a polarizing plate stuck thereon for each liquid crystal cell, it is necessary to remove the polarizing plate of a strip region having a width allowing a substrate dividing tool to travel therethrough. Patent Document 1 describes previously providing the polarizing plate with a cut to provide cells, However, while the cut can divide the polarizing plate for each cell, the cut does not ensure a strip region allowing the substrate dividing tool to travel therethrough, and the tool cannot be applied to the surface of the substrate. The present inventors have tried the method of fabricating a display panel as described in Patent Document 2, and found that while the polarizing plate can be removed, an adhesive layer bonding the polarizing plate and the substrate together may remain on the surface of the substrate and that the residual adhesive layer prevents the subsequent division of the substrate.

Accordingly the present invention contemplates a display panel, a display panel fabrication method and a removal apparatus such that when a polarizing plate of a predetermined region should be removed for example for division of a substrate, the polarizing plate can completely be removed from a surface of the substrate and a subsequent division step can reliably be performed.

### Means for Solving the Problems

To achieve the above object, the present invention provides a display panel including: a first substrate; a second substrate superposed on the first substrate with a display layer posed therebetween; a sealing member disposed between the first substrate and the second substrate and surrounding the display layer; a resin layer disposed on at least one of the first substrate and the second substrate at a surface facing away from the display layer; and a polarizing plate stuck on a surface of the resin layer,

### Effects of the Invention

In accordance with the present invention, when a polarizing plate of a predetermined region should be removed for example for division of a substrate, the polarizing plate can completely be removed from a surface of the substrate and a subsequent division step can reliably be performed, and a display panel that can be readily fabricated can thus be provided.

### BRIEF DESCRIPTION OF THE DRAWINGS

FIG. 1 is a diagram for illustrating a method of fabricating a display panel in accordance with the present invention in a first embodiment.

FIG. 2 is a perspective view of a large size stack of substrates in a first step of the method of fabricating the display panel in accordance with the present invention in the first embodiment.

FIG. 3 is a partially enlarged cross section of a typical stack of substrates after it is divided.

FIG. 4 is a partially enlarged cross section of a large size stack of substrates obtained in the method of fabricating the display panel in accordance with the present invention in the first embodiment.

FIG. 5 is a perspective view of the large size stack of substrates in a second step of the method of fabricating the display panel in accordance with the present invention in the first embodiment.

FIG. 6 is a partially enlarged cross section of the large size stack of substrates in the second step of the method of fabricating the display panel in accordance with the present invention in the first embodiment.

FIG. 7 is a perspective view of the large size stack of substrates in a third step of the method of fabricating the display panel in accordance with the present invention in the first embodiment.

FIG. 8 is a partially enlarged cross section of the large size stack of substrates in the third step of the method of fabricating the display panel in accordance with the present invention in the first embodiment.

FIG. 9 is a diagram for illustrating a peeling step of a division step in the method of fabricating the display panel in accordance with the present invention in the first embodiment.

FIG. 10 is a diagram for illustrating a condition after the peeling step of the division step in the method of fabricating the display panel in accordance with the present invention in the first embodiment.

FIG. 11 is a perspective view of a first example of a peeling tool used in the method of fabricating the display panel in accordance with the present invention in the first embodiment.

FIG. 12 is a perspective view of a second example of the peeling tool used in the method of fabricating the display panel in accordance with the present invention in the first embodiment.

FIG. 13 is a diagram for illustrating a condition after a glass dividing step of the division step in the method of fabricating the display panel in accordance with the present invention in the first embodiment.

FIG. 14 is a diagram for illustrating a condition after the division step in the method of fabricating the display panel in accordance with the present invention in the first embodiment.

FIG. 15 is a flowchart of the method of fabricating the display panel in accordance with the present invention in the first embodiment.

FIG. 16 is a flowchart of a method of fabricating a display panel by conventional art.

FIG. 17 is a side view of a display panel in accordance with the present invention in a second embodiment.

FIG. 18 is a partially enlarged cross section of the display panel in accordance with the present invention in the second embodiment.

FIG. 19 is a first view for illustrating a method of fabricating a liquid crystal display panel by conventional art.

FIG. 20 is a second view for illustrating the method of fabricating the liquid crystal display panel by conventional art.

FIG. 21 is a third view for illustrating the method of fabricating the liquid crystal display panel by conventional art.

FIG. 22 is a fourth view for illustrating the method of fabricating the liquid crystal display panel by conventional art.

### DESCRIPTION OF THE REFERENCE SIGNS

4: liquid crystal, 5a, 5b: resin layer, 101, 102, 101i, 102i: glass substrate, 103: sealing member, 104: liquid crystal, 105: sealing resin, 108: FPC, 109: terminal portion, 114: stack of substrates, 115: liquid crystal cell, 116: inlet, 150: liquid crystal display panel, 203: common electrode pad, 205: conductive material, 209: conductive granule, 210: common transition electrode, 306a, 306b: polarizing plate, 314: (large size) stack of substrates, 411: strip region, 412: division line, 461: cutter.

### BEST MODES FOR CARRYING OUT THE INVENTION

### First Embodiment

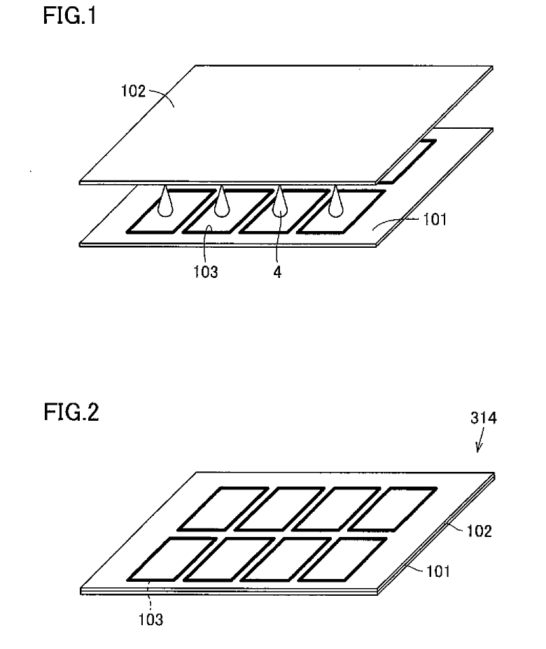

Reference will now be made to FIG. 1 to FIG. 14 to describe a method of fabricating a display panel in accordance with the present invention in a first embodiment. In the present embodiment the method of fabricating the display panel includes the steps of: sticking a first substrate and a second substrate together, with a display layer sandwiched therebetween, to form a stack of substrates; applying resin on a surface of at least one of the first and second substrates to deposit a resin layer thereon; sticking a polarizing plate on the surface of the substrate having the resin layer; and dividing the stack of substrates in the form of a plurality of display panels. Herein as one example of the display panel a liquid crystal display panel is exemplified. Accordingly, a method of fabricating a liquid crystal display panel will be described hereinafter.

Initially, as shown in FIG. 1, if glass substrate 101 serving as a CF substrate and glass substrate 102 serving as a TFT substrate are stuck together, then before the substrates are stuck together, sealing member 103 is deposited on one of the two substrates. Sealing member 103 may be applied with a dispenser from a small syringe or it may be applied by screen-printing. In the FIG. 1 example, glass substrate 101 has a surface having sealing member 103 applied thereon. Sealing member 103 is deposited to surround continuously an entire periphery of a region to be provided with a liquid crystal layer. In other words, sealing member 103 does not have the opening that the conventional sealing member 103 shown in FIG. 19 does. The present invention exhibits a particularly significant effect when a large size substrate is used to produce large numbers of medium- and small-size liquid crystal display panels therefrom. Such medium- and small-size liquid crystal display panels are mainly applied in mobile phones, car navigation systems and the like, which are required to endure temperature higher than office automation equipment, which mainly employs a large size liquid crystal display panel, is. Accordingly, sealing member 103 is heat-resistant, photo-curing resin. Alternatively, sealing member 103 may be thermosetting resin or a type of resin set by light and heat together applied thereto.

In the step of dropping liquid crystal, liquid crystal 4 is dropped inside sealing member 103. Liquid crystal 4 is dropped in an amount matching the volume of a cell and accumulates inside sealing member 103. FIG. 1 schematically shows liquid crystal 4 being dropped. In this condition the substrates are stuck together. More specifically, glass substrate 1 02 is laid on glass substrate 101 in a vacuum, and the intermediate product is exposed for example to ultraviolet light, and heated, as required, to set sealing member 103 to hermetically seal liquid crystal 4 in the cell. Thus a large size stack of substrates 314 is obtained as shown in FIG. 2. In FIG. 2, scaling member 103 is seen through glass substrate 102.

Alternatively, rather than dropping liquid crystal inside the sealing member on one substrate, the step of dropping liquid crystal may be performed by dropping liquid crystal on the other substrate to be stuck on the substrate having the sealing member thereon, at a predetermined position corresponding to a portion inside the sealing member.

Glass substrates 101 and 102 are both provided with electrodes, respectively, for applying voltage to liquid crystal When a liquid crystal display panel is completed, however, it is desirable that it have the electrodes externally extracted through a terminal portion provided only at one substrate exclusively. Accordingly, the electrode of the substrate without the terminal portion must be extracted from the substrate without the terminal portion to the substrate with the terminal portion. To do so, a common transition electrode is used.

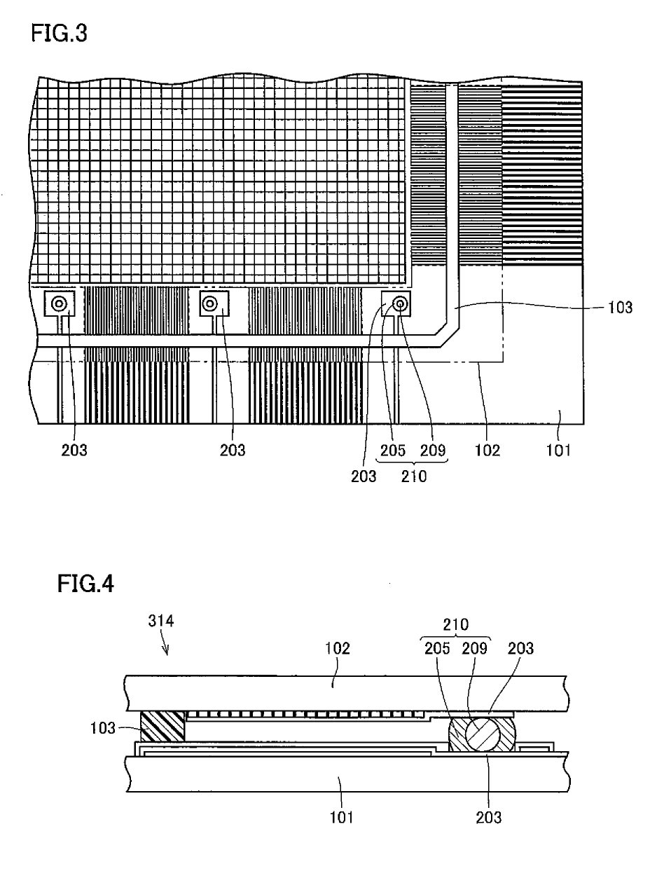

The common transition electrode will now be described hereinafter. A “common transition electrode” is an electrode sandwiched between opposite glass substrates, with a liquid crystal layer posed therebetween, to allow electrical conduction between the electrodes of the surfaces of the glass substrates, respectively; FIG. 3 shows an enlarged view of a portion of the stack of substrates 314. The stack of substrates 314 is an undivided, large size stack of substrates. FIG. 3, however, enlarges for the sake of illustration a portion of the stack of substrates having been divided. On glass substrates 101, 102 inside sealing member 103 a plurality of common electrode pads 203 are disposed with their respective, small, round common transition electrodes 210 disposed therein. From common electrode pad 203 an interconnection extends across sealing member 103 toward an outer edge of the liquid crystal display panel. Common transition electrode 210 is configured to include at a center thereof a small, round, conductive granule 209 having an external surface wrapped with a conductive material 205. When the substrates are stuck together, common transition electrode 210 is sandwiched between upper and lower common electrode pads 203 and squashed thereby. As a result, as shown in FIG. 4 in cross section, with conductive granule 209 interposed, upper and lower glass substrates 101 and 102 face each other, and conductive material 205 having been squashed and deformed surrounds conductive granule 209. Electrical conduction is thus achieved between the electrode on a surface of glass substrate 101 and that on a surface of glass substrate 102. In the present embodiment the method of fabricating the liquid crystal display panel is performed by superposing the glass substrates, one on the other, in a vacuum and recovering the atmospheric pressure to utilize the atmospheric pressure as a pressure applied to stick the substrates together. With this pressure applied, the intermediate product is exposed to ultraviolet ray, heated, and/or the like to set the sealing member.

Returning to the end of the step of sticking the substrates together, description will be continued. The step of sticking the substrates together provides the large size stack of substrates 314, as shown in FIG. 2.

In the step of applying resin, resin is applied on a surface of the stack of substrates 314 with a spin coater, by dipping, dispensing, or a similar system, and set to provide a resin layer 5a as shown in FIG. 5. “Resin” as referred to herein may for example be acrylic resin. The resin is applied on an externally exposed surface of glass substrate 102 for example. After the resin is applied, a heat treatment is performed at approximately 100° C. to 200° C. to provide a resin layer of 10 to 50 μm in thickness. If sealing member 103 is a thermosetting sealing member, the sealing member and the resin layer may thermally be set simultaneously.

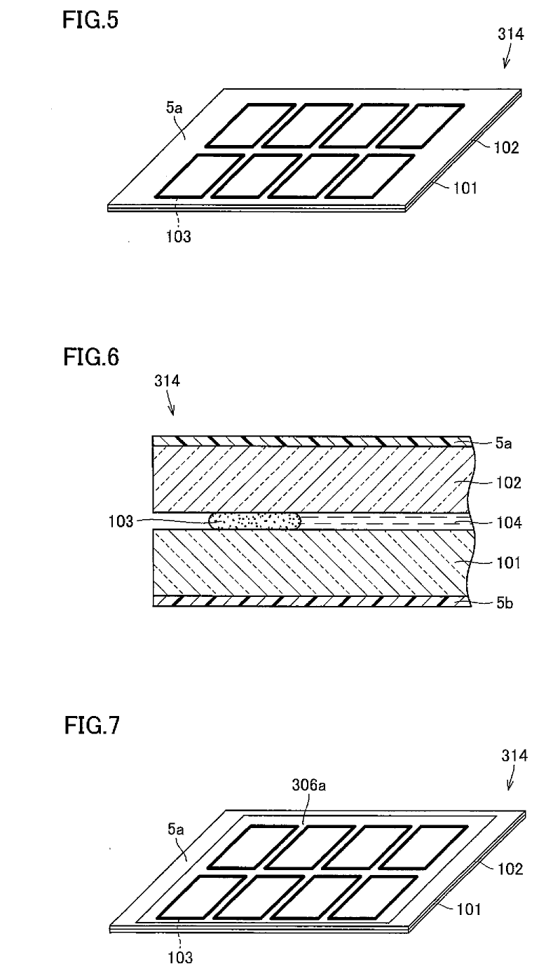

The resin layer may be disposed not only on one surface but also on opposite surfaces. As one example of depositing resin layers on opposite surfaces, FIG. 6 shows a partially enlarged cross section of the stack of substrates 314 having resin layers 5a, 5b. Herein, glass substrate 102 has a surface with resin layer 5a and glass substrate 101 has a surface with resin layer 5b. Glass substrates 101, 102 sandwich liquid crystal layer 104 surrounded by sealing member 103.

The present embodiment employs a resin layer formed of thermosetting resin. Alternatively, ultraviolet (UV) curing resin may be used to form resin layer 5a, 5b. The resin includes types of resin, such as epoxy resin, polyether sulfone (PES) resin, urethane resin, vinyl acetate resin and similar organic resin. The resin layer is mainly configured of organic resin. Furthermore it is preferable to replace organic resin with a hybrid material significantly adhesive to a glass substrate, as the hybrid material can enhance modulus of elasticity, hardness and like mechanical properties and significantly enhance thermal resistance and chemical resistance. The hybrid material is configured of inorganic colloidal particles and an organic binder resin. The hybrid material is configured for example of inorganic colloidal particles for example of silica, and an organic binder resin such as epoxy resin, polyurethane acrylate resin, polyester acrylate resin, or the like.

After the large size stack of substrates 314 (see FIG. 5) has undergone the step of applying a resin layer, a polarizing plate is stuck thereon to cover resin layer 5a. The polarizing plate to be stuck may be supplied in the form of a roll, or may alternatively be an optical correction film cut to have a size substantially equal for example to that of the stack of substrates 314. Alternatively, it may be cut to have a size of an extent equal to a total in area of a plurality of liquid crystal cells. Alternatively, it may be cut to have an area larger than that of at least one liquid crystal cell.

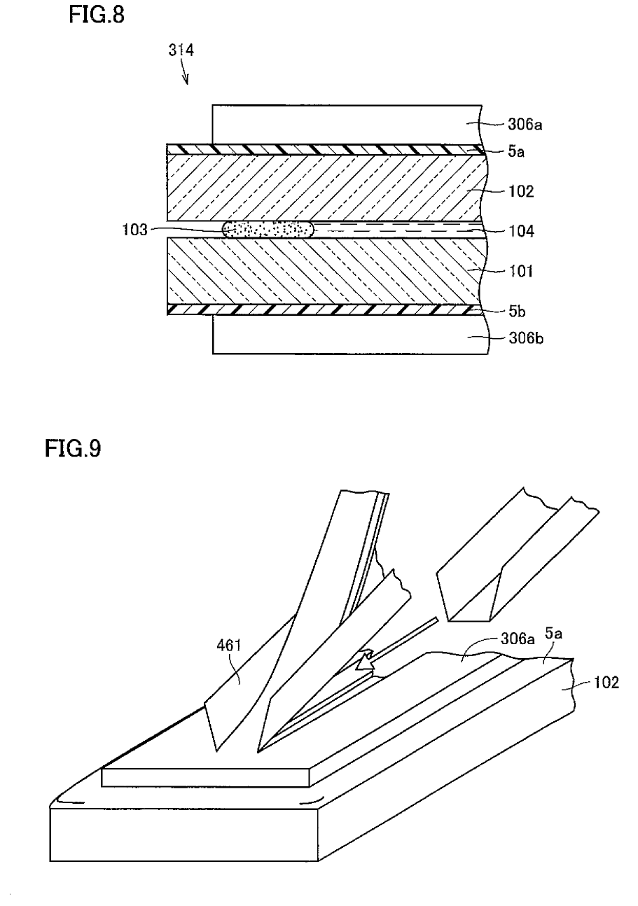

Herein as one example a polarizing plate 306a having a size approximately equal to that of the stack of substrates 314 is stuck, as shown in FIG. 7. If the polarizing plate is stuck on opposite surfaces, a cross section is provided as shown in FIG. 8. In FIG. 8, glass substrate 102 has an upper surface having resin layer 5a covered with polarizing plate 306a, and glass substrate 101 has a lower surface having resin layer 5b covered with a polarizing plate 306b.

Then a division step is performed to divide the stack of substrates 314 to have a size of an individual liquid crystal display panel. In the division step, the two glass substrates stuck together, resin layer Sa deposited on a surface thereof, and polarizing plate 306a stuck thereon are divided, all at once, such that they overlap each other. As a result of the division step, each liquid crystal display panel is divided for each liquid crystal cell. In the present embodiment the method of fabricating a display panel is performed by partially removing the polarizing plate on at least one of the first and second substrates together with the resin layer to expose a surface of the substrate(s) and subsequently dividing the first and second substrates.

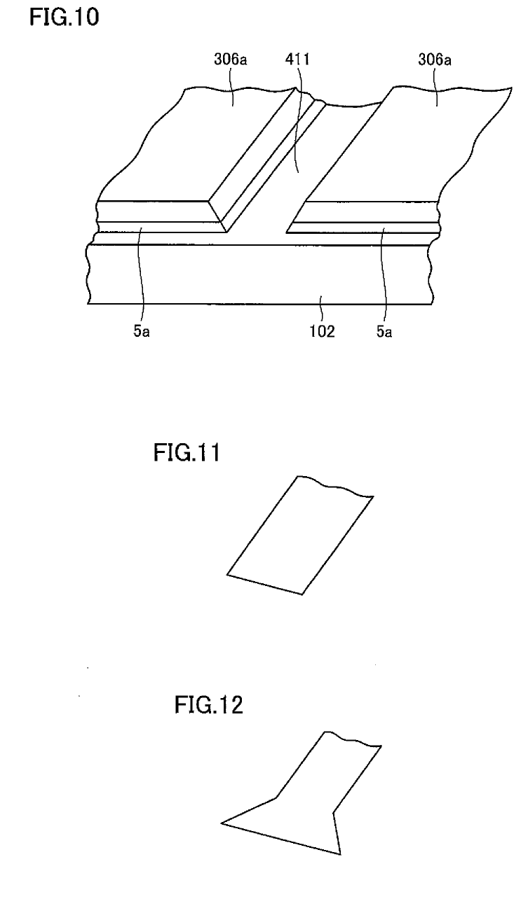

The division step will more specifically be described hereinafter with reference to FIG. 9 to FIG. 14. The division step includes a peeling step and a glass dividing step. In the peeling step, as shown in FIG. 9, a peeling tool implemented as a cutter 461 is used to peel off together polarizing plate 306a and resin layer 5a having set. Cutter 461 has a cross section in the form of a horseshoe opened slightly wider. Traveling cutter 461 on polarizing plate 306a provides polarizing plate 306a with a cut, which forms a strip region 411 exposing glass substrate 102 in the form of a strip, as shown in FIG. 10. Furthermore, to form strip region 411 to have a desired width, a single cutter or cutters identical in geometry may be traveled more than once. This can form a strip region having a width equal to or larger than that of the cutter.

In the present embodiment a polarizing plate is not stuck directly on a glass substrate. Rather, it is stuck on a resin layer deposited on a surface of the glass substrate. In other words, the polarizing plate has an adhesive layer that is used for adhesion to the resin layer, rather than adhesion to the glass substrate per se. As such, peeling off polarizing plate 306a by cutter 461 together with resin layer 5a can peel off polarizing plate 306a and resin layer 5a without leaving the adhesive layer on glass substrate 102.

The peeling tool is not limited to a geometry of cutter 461 as shown in FIG. 9; it may be any tool that includes a portion in the form of a spatula to remove the resin layer and the polarizing plate from glass substrate 102. For example, it may have geometries as shown in FIGS. 11 and 12. It should be noted, however, that for the FIGS. 11 and 12 geometries, it is preferable that the polarizing plate be previously cut in the form of a strip.

When the polarizing plate and the resin layer are peeled off, resin layer 5a is peeled off by the peeling tool and is also partially crushed thereby. As a result, crushed chips of resin are left behind the peeling tool, Accordingly it is preferable that a cleaning mechanism be provided behind the peeling tool to remove the chips of resin. Specifically, the cleaning mechanism is a brush mechanism, an air blower, an air suction port, or the like. Such cleaning mechanism can prevent a surface of a glass substrate exposed by the peeling tool from having the resin layer's crushed chips left thereon, and the subsequent glass division can reliably be performed. If the cleaning mechanism is implemented as the air blower or by air suction, it may be provided in front or at a side of the cutter, rather than behind the cutter.

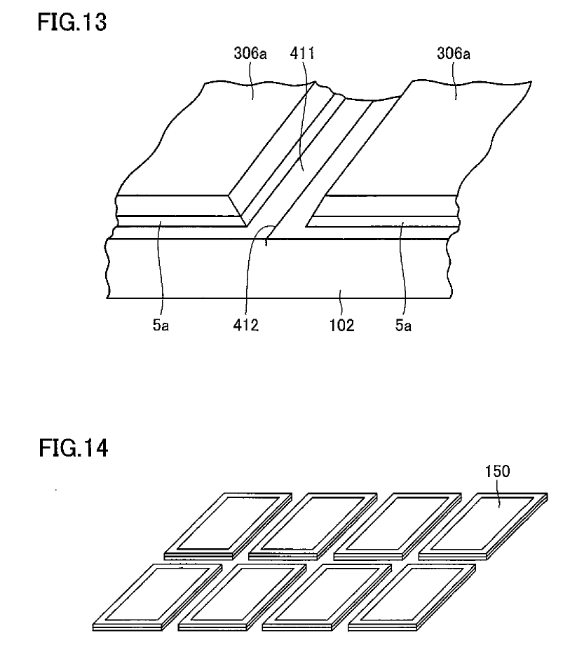

After the peeling step by causing the peeling tool to travel exposes a surface of glass substrate 102 along strip region 411, the glass dividing step is performed by causing a glass dividing tool (not shown) to travel on strip region 411. Thus, as shown in FIG. 13, a division line 412 is formed. Division line 412 is a scratch made on the surface of glass substrate 102, and this scratch, serving as a starting point to divide glass substrate 102, allows glass substrate 102 to be divided linearly. In doing so, a unit having cutter 461 (see FIG. 9) and the glass dividing tool together incorporated therein may be traveled on glass substrate 102 to simultaneously perform the step of exposing strip region 411 of a surface of glass substrate 102 and the step of dividing glass substrate 102. In doing so, the glass dividing tool may be any known such tool. The glass dividing tool is not limited in form. It may for example be in the form of a wheel.

The division step thus ends, and the large size stack of substrates is thus divided into individual liquid crystal display panels 150 as shown in FIG. 14. In the FIG. 14 example, only eight liquid crystal display panels 150 are shown. However, the number of liquid crystal display panels is not limited to eight, and may be set as appropriate. For example, a single large size stack of substrates may be divided into hundreds of liquid crystal display panels.

The unit used in the division step removes a polarizing plate and a resin layer from a surface of a stack of substrates. Accordingly, the unit can also be considered as a “removal apparatus.”

The present embodiment provides a removal apparatus preferably including a peeling tool traveled along a surface of a substrate to peel a polarizing plate and a resin layer off the substrate, and a cleaning mechanism disposed in front of or behind the peeling tool, as seen in a direction in which the peeling tool moves, to remove chips of resin peeled or crushed by the peeling tool.

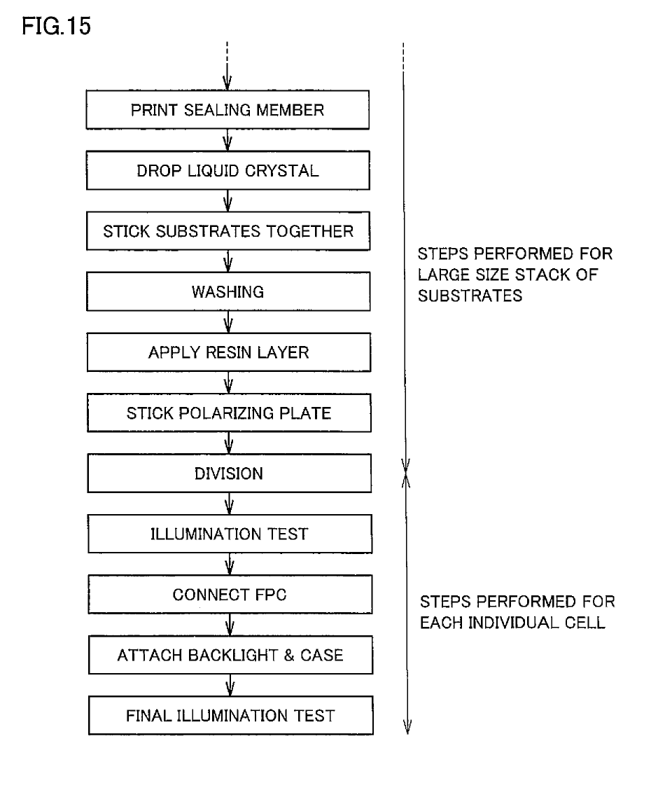

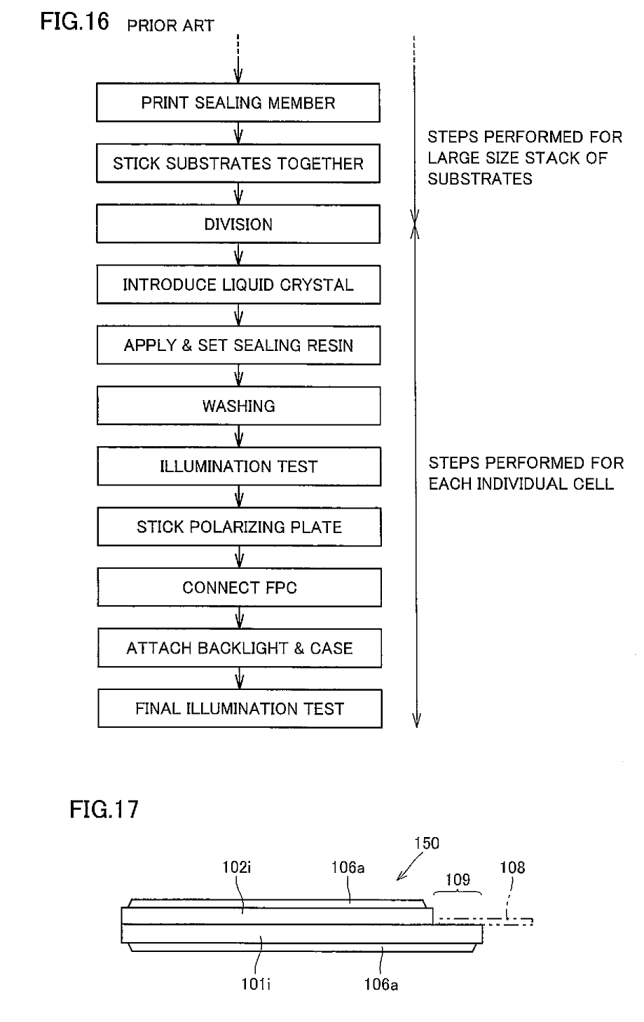

The method of fabricating a liquid crystal display panel in the present embodiment is shown in a flowchart, as shown in FIG. 15. The liquid crystal display panel completes in the FIG. 15 flowchart at the division step. Note that FIG. 15 also indicates steps performed after the liquid crystal display panel completes. More specifically, a flexible printed circuit (FPC) is connected to a terminal portion of the liquid crystal display panel and a backlight and a case are attached to obtain a liquid crystal display device. In a conventional fabrication method, as shown in FIG. 16, the division is performed at an early stage. Accordingly it is necessary to perform a large number of steps for each individual liquid crystal display panel. In contrast, the present embodiment provides a method of fabricating a liquid crystal display panel, that allows a large number of steps to be performed before the division, i.e., with substrates still having a large size, and the liquid crystal display panel or device can be fabricated significantly efficiently. This can significantly reduce a period of time required for one liquid crystal display panel.

### Second Embodiment

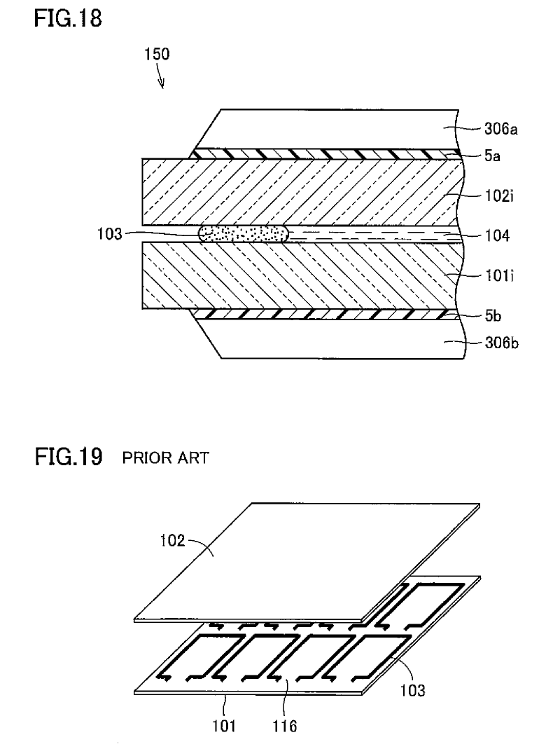

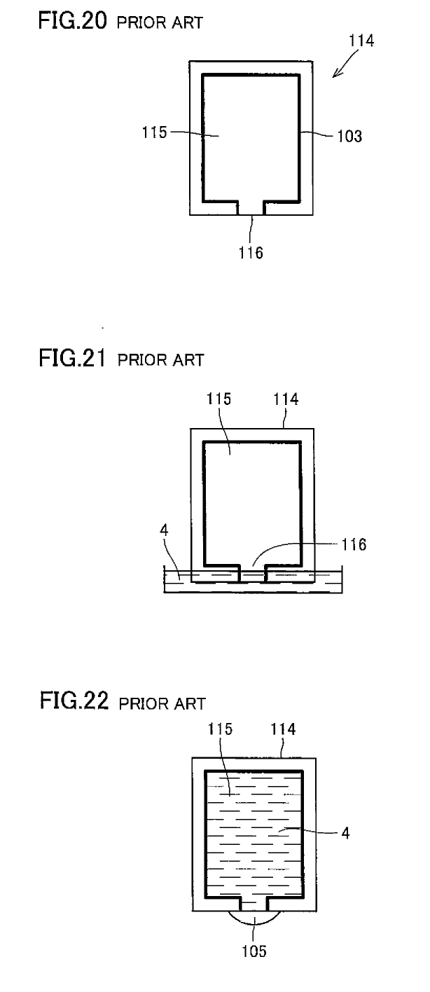

With reference to FIG. 17 and FIG. 18, the present invention in a second embodiment provides a display panel, as will be described hereinafter. Herein, as one example of the display panel, a liquid crystal display panel 150 shown in FIG. 17 will be described. Liquid crystal display panel 150 is obtained from the large size stack of substrates divided, as has been described in the first embodiment with reference to FIG. 14. Glass substrates 101i, 102i are divided from large size glass substrates 101, 102 (see FIG. 7 for example), respectively. Preferably, liquid crystal display panel 150 has one substrate extending to be larger in length than the other substrate as a terminal portion 109 for connecting an FPC 108 at one end, as shown in FIG. 17. FIG. 18 shows an enlarged cross section of a left end portion of liquid crystal display panel 150.

The present embodiment provides liquid crystal display panel 150 including glass substrate 101i serving as a first substrate, glass substrate 102i serving as a second substrate superposed on the first substrate with liquid crystal layer 104 posed therebetween to serve as a display layer, sealing member 103 disposed between the first and second substrates and surrounding the display layer, resin layer 5a, 5b disposed on at least one of the first and second substrates at a surface facing away from the display layer, and polarizing plate 306a, 306b stuck on a surface of the resin layer.

Between glass substrates 101i and 102i liquid crystal layer 104 is disposed such that it is surrounded by sealing member 103. Resin layer 5a, 5b is peeled off by the peeling tool together with the polarizing plate in the step of peeling off an unnecessary portion of the polarizing plate. The region having the polarizing plate removed therefrom thus also does not have the resin layer. Polarizing plates 306a, 306b have ends receding from those of substrates 101i, 102i, respectively, and polarizing plates 306a, 306b are stuck on surfaces of resin layers 5a, 5b, respectively. In this case, as shown in FIGS. 10 and 13, strip region 411 exposing a surface of a substrate is formed, and this portion has the resin layer and the polarizing plate removed therefrom.

The present embodiment provides a display panel having the resin layer only at a region covered with the polarizing plate. Preferably, resin layer 5a, 5b contains a hybrid material configured of inorganic colloidal particles and an organic binder resin, since such hybrid material can enhance modulus of elasticity, hardness and like mechanical properties, and thermal resistance and chemical resistance. Resin layer 5a, 5b preferably has a thickness of at most 50 μm.

In liquid crystal display panel 150 (see FIG. 17) sealing member 103 continuously surrounds an entire periphery of a liquid crystal layer. “Continuously surrounding an entire periphery of . . . ” as referred to herein means completely enclosing it without discontinuity.

While FIG. 18 shows that two glass substrates 101i, 102i are provided with resin layers 5a, 5b, respectively, and polarizing plates 306a, 306b stuck outwardly of them, respectively, by way of example, only one glass substrate may be provided with a resin layer and a polarizing plate stuck thereon, depending on the system, purpose and the like of the liquid crystal display panel of interest. Furthermore, opposite surfaces may be provided with resin layers, respectively, and only one resin layer may have a polarizing plate stuck thereon.

While the above embodiments have been described for a substrate implemented as a glass substrate, the substrate is not limited to the glass substrate, and may be a substrate of other material.

The present embodiment provides a display device that has a resin layer on an outer surface of a substrate, and a polarizing plate disposed to cover a surface of the resin layer. This is convenient, since in peeling off the polarizing plate of a partial region the polarizing plate can be peeled off together with the resin layer to dispose the polarizing plate only at a desired region. When the polarizing plate is peeled off, it can be done so together with the resin layer underlying the polarizing plate. This can prevent the polarizing plate from having its adhesive layer disadvantageously, partially left. This can provide such a display panel that when a polarizing plate of a predetermined region should be removed for example for division of a substrate the polarizing plate can completely be removed from a surface of the substrate and a subsequent division step can reliably be performed.

It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### INDUSTRIAL APPLICABILITY

The present invention is applicable to display panels, display panel fabrication methods and removal apparatuses.

1. A display panel comprising:
a first substrate;
a second substrate superposed on said first substrate with a display layer posed therebetween;
a sealing member disposed between said first substrate and said second substrate and surrounding said display layer;
a resin layer disposed on at least one of said first substrate and said second substrate at a surface facing away from said display layer; and
a polarizing plate stuck on a surface of said resin layer.

2. The display panel according to claim 1, wherein said resin layer is disposed only at a region covered with said polarizing plate.

3. The display panel according to claim 1, wherein said resin layer contains a hybrid material configured of inorganic colloidal particles and an organic binder resin.

4. A method of fabricating a display panel, comprising the steps of:
sticking a first substrate and a second substrate together, with a display layer sandwiched therebetween, to provide a stack of substrates;
applying resin on a surface of at least one of said first substrate and said second substrate to deposit a resin layer thereon;
sticking a polarizing plate on a surface of said substrate having said resin layer; and
dividing said stack of substrates in a form of a plurality of display panels.

5. The method of fabricating a display panel according to claim 4, wherein said polarizing plate is partially removed from said at least one of said first substrate and said second substrate together with said resin layer to expose a surface of said substrate, and said first substrate and said second substrate are subsequently divided.

6. A removal apparatus comprising:
a peeling tool traveled along a surface of a substrate to peel a polarizing plate and a resin layer off said substrate; and
a cleaning mechanism disposed in front of or behind said peeling tool, as seen in a direction in which said peeling tool moves, to remove chips of resin peeled or crushed by said peeling tool.
